(19) United States
(12) Patent Application Publication
(10) Pub. No.: US 2011/0183753 A1
(43) Pub. Date: Jul. 28, 2011

(54) SYSTEM FOR PLAYING BACCARAT

(75) Inventors: Noah S. Acres, Las Vegas, NV (US); John F. Acres, Las Vegas, NV (US)

(73) Assignee: ACRES-FIORE PATENTS, Las Vegas, NV (US)

(21) Appl. No.: 12/692,407

(22) Filed: Jan. 22, 2010

(51) Int. Cl. A63F 13/00; A63F 1/00; A63F 9/24

(52) U.S. Cl. 463/31; 273/292; 463/42

(57) ABSTRACT

Embodiments of the present invention are directed to overcoming a problem of finding information about neighboring players in an electronic baccarat system by displaying each player's bet on each game, along with a statistical summary of how that person is doing, thereby making it easy for players to see what others are doing and recall whether they've been consistently winning or not. Additionally, embodiments of the invention provide a mechanism by which a player can select a player to bet upon and enact that wager, or multiple thereof, through a gaming machine. Further, embodiments of the invention provide an interesting manner of handling tie outcomes. Because tie bets are relatively rare in baccarat, embodiments of the invention provide a mechanism to increase the likelihood of making a tie event, along with the opportunity for a player to profit from such a successful wager.

### FIELD OF THE INVENTION

This disclosure relates generally to gaming devices, and more particularly to a system for playing baccarat that may be played at either an electronic gaming device or as a table game.

### BACKGROUND

Baccarat rules are well known. Although variations exist, in general, two hands are dealt, one for the “Banker” and one for the “Player.” The numeric value of each party's cards are totaled, modulo 10, with numeric cards having their displayed value, and Tens and face-cards having values of “0.” Aces are valued at 1. Highest score wins the hand. Ties are possible and may be bet separately. Other rules include special cases where either the Banker or Player is given an additional card. Therefore, Baccarat rounds are always played with exactly four, five, or six cards, with each party having two or three cards. As noted above, variations to Baccarat are common and are well known.

Traditionally, Baccarat is played as a “live” game, at a table having a human dealer and multiple player seats. For many players Baccarat is a social game with interaction between the casino, players and observers. Other players prefer anonymity. Although electronic Baccarat games have been tried before, they oftentimes fail for a variety of reasons. One reason for failure is that interaction between players is lost at electronic games. At a table game, players can easily interact with one another by physically standing near one another. Electronic games, however, are almost necessarily spread out, which minimizes such interaction.

Embodiments of the invention address these and other limitations of the prior art.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 is a block diagram of a table game having a connection to the gaming network of FIG. 3.

FIG. 5 is a diagram of a baccarat screen on a display device according to embodiments of the invention.

FIG. 6 is a block diagram of a detailed portion of the player history section of the baccarat screen of FIG. 5.

FIG. 7A is a diagram illustrating a round of baccarat in which a tie is not naturally dealt, but can be made by rearrangement.

FIG. 7B is a diagram illustrating another round of baccarat in which a tie is not naturally dealt but can be made by rearrangement.

FIG. 7C is a diagram illustrating another round of baccarat in which a tie is not naturally dealt, nor can be made by rearrangement.

### DETAILED DESCRIPTION

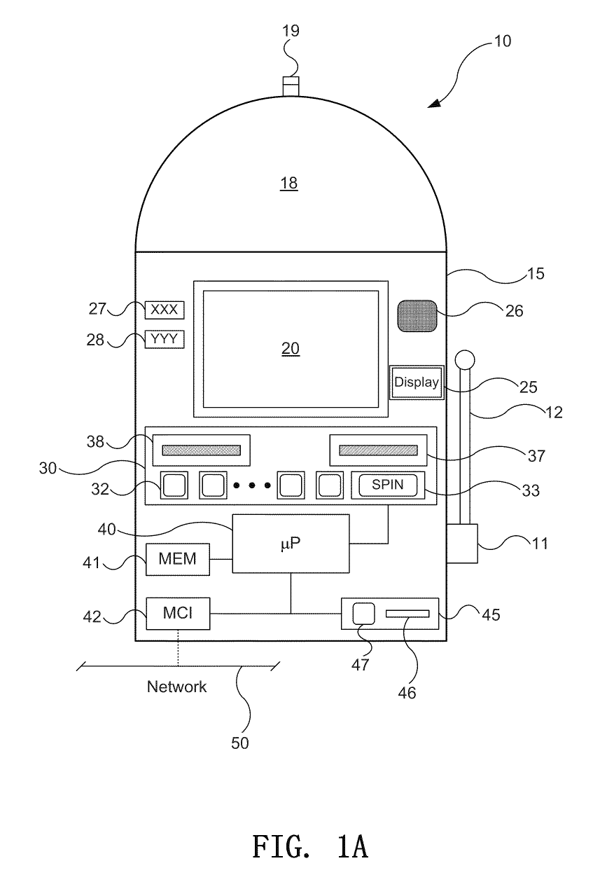

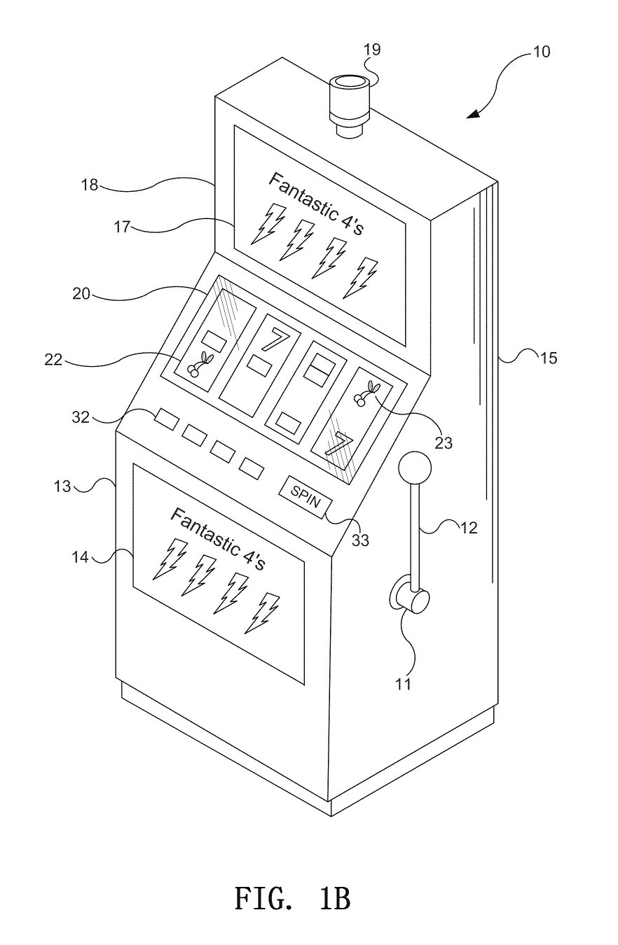

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electro-mechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

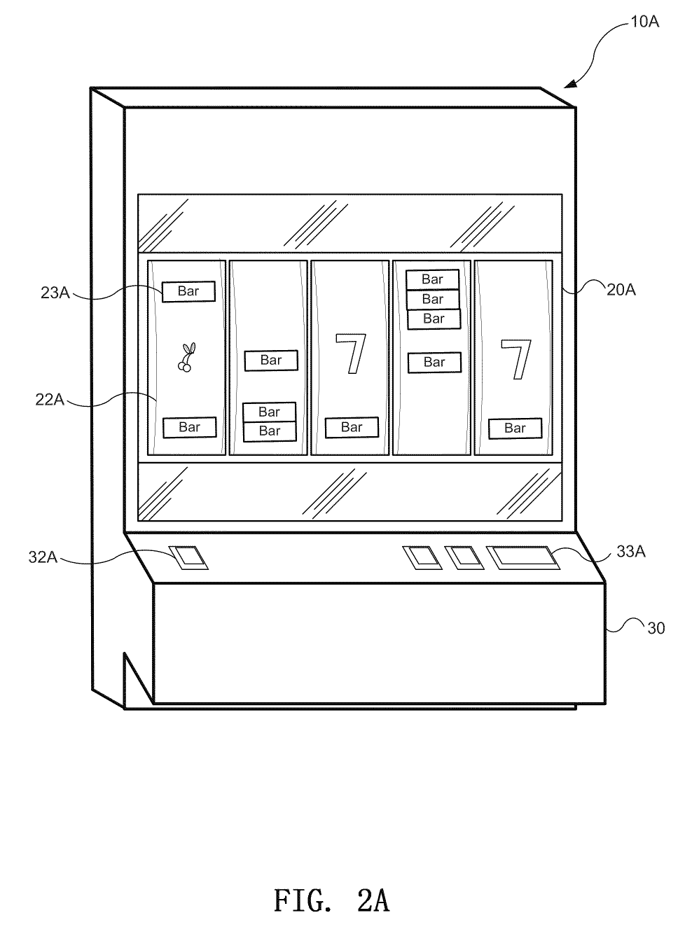

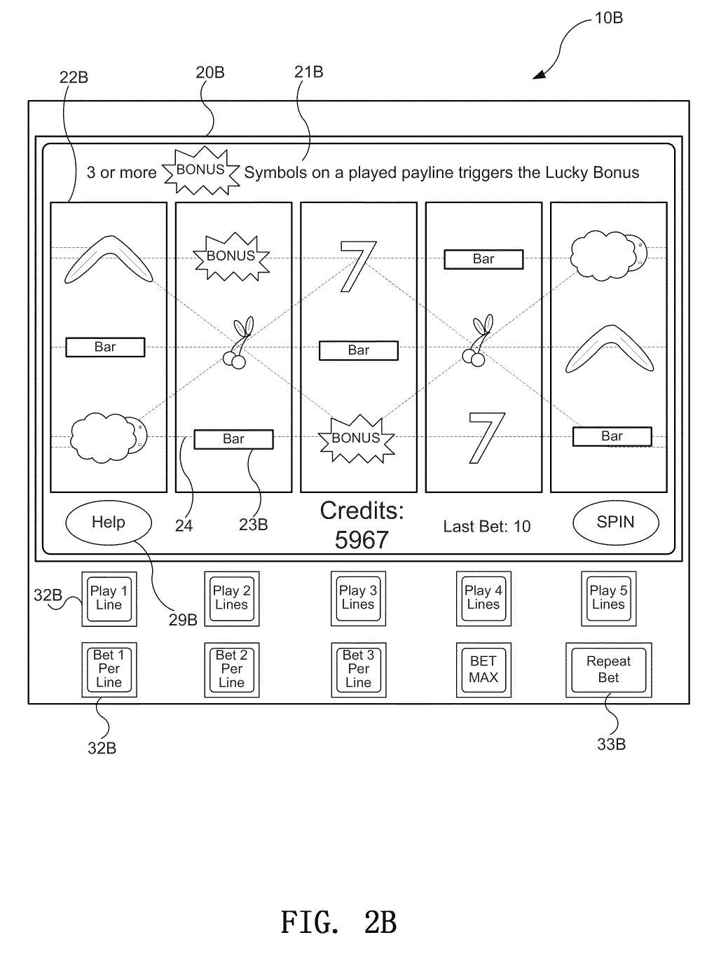

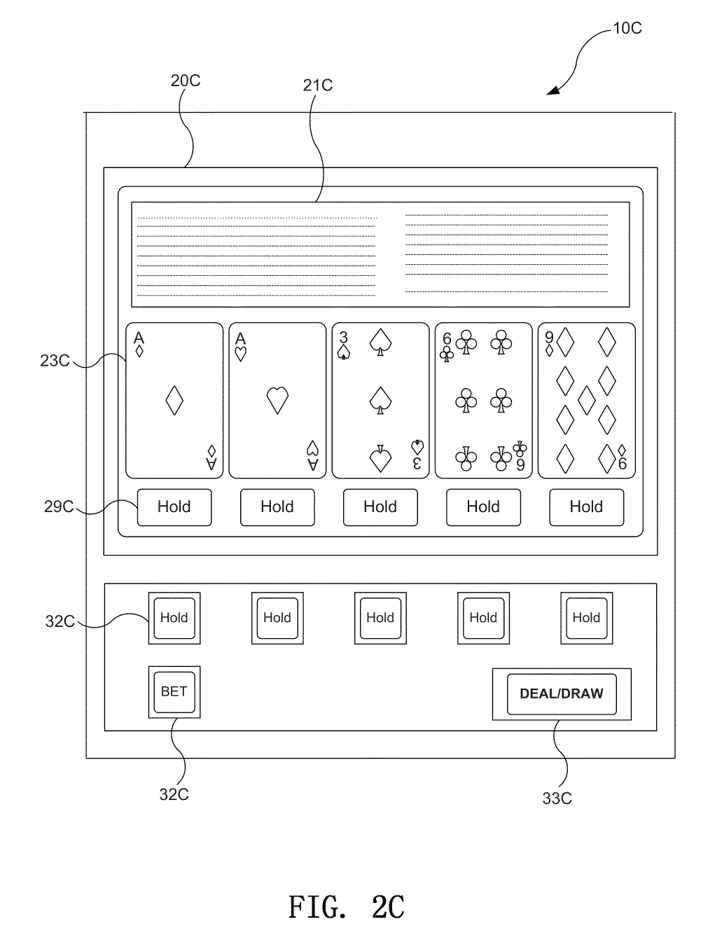

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window”. Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

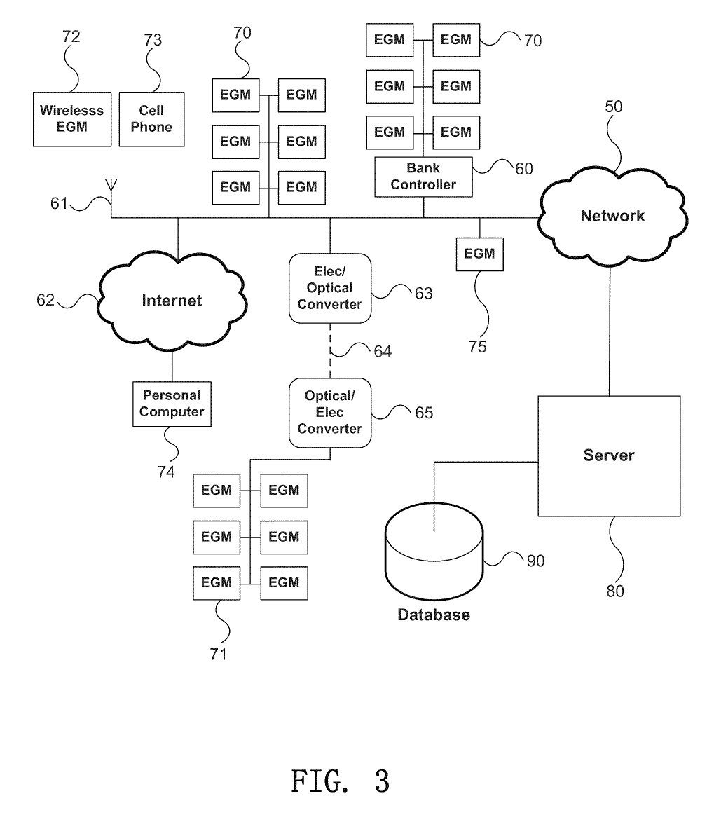

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). In other embodiments, stored player points or special ‘bonus points’ awarded to the player or accumulated and/or stored in a player account may be able to be substituted at or transferred to the gaming device 10 for credits or other value. For example, a player may convert stored loyalty points to credits or transfer funds from his bank account, credit card, casino account or other source of funding. The selected source of funding may be selected by the player at time of transfer, determined by the casino at the time of transfer or occur automatically according to a predefined selection process. One of skill in the art will readily see that this invention is useful with all gambling devices, regardless of the manner in which wager value-input is accomplished.

The credit meter 27 displays the numeric credit value of the money or other value inserted, transferred, or stored dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11 a, b, g, or n, Zigbee, RF protocols, optical transmission, near-field transmission, or the like.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

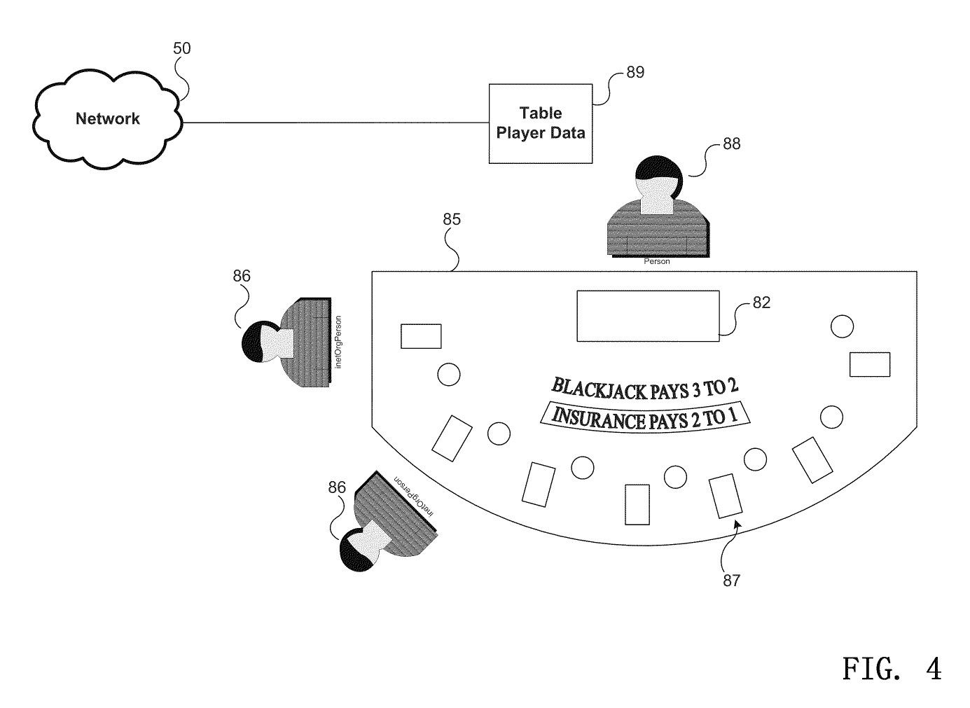

FIG. 4 is an example block diagram of a table game having a connection to the gaming network 50 of FIG. 3. In FIG. 4, a blackjack table 85 includes a number of stations 87 at which players 86 may sit. A dealer 88 typically manages the table, dealing the cards as a blackjack game, paying or collecting bets, and exchanging chips for money, etc. Additionally some table game areas include a data entry device 89 that is coupled to the gaming network 50 described with reference to FIG. 3 above.

In some instances, if the table player is playing as an identified player, the player 86 gives the dealer 88 (or other casino personnel) a player tracking card to swipe, or other identifying information, which is then associated with the position of the table 85 at which the player is sitting. The dealer 88 or other casino personnel may enter data about the players 86 through the data entry device 89 to record data about the players within the computer network 50. Such data may be stored on the server 80 and/or the database 90. For instance data may be stored related to the amount each player 86 is playing over a time period, such as an hour. For instance the dealer 88 may note if the player 86 is making a series of relatively constant bets, or a many bets of various size.

The various systems described with reference to FIGS. 1-4 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

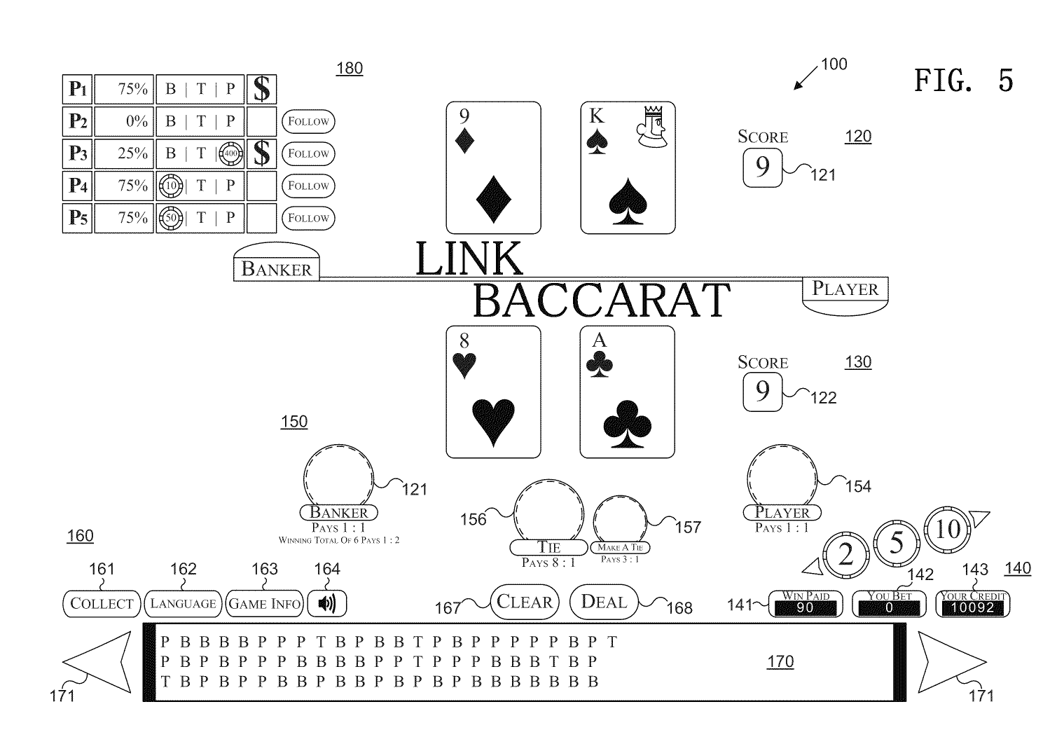

FIG. 5 is a diagram of a baccarat screen 100 on a gaming device according to embodiments of the invention. For example the screen 100 may be a display on any of the EGMs 70-75 described above with reference to FIG. 3. In most embodiments each separate gaming device will include a single baccarat screen 100. For example, with reference back to FIG. 3, a group of EGMs 70 may be coupled to the bank controller 60, with each of the connected EGMs 70 including its own baccarat screen 100 as illustrated on FIG. 5. The EGMs 70 need not be located physically close to one another, and, in fact may be widespread through a casino or through multiple properties. In some embodiments the EGM 74 may be a personal computer displaying the baccarat screen 100 through the internet 62. In other embodiments the EGM 73 may be displaying the baccarat screen 100 on a cellular phone or other hand-held device.

In yet other embodiments the baccarat screen 100 may be displayed as a large communal screen at a particular area of a casino, or other public place, and players may interact with the baccarat screen using hand-held EGMs 73 or using other methods.

In still further embodiments, the dealer may be performed by a live dealer, who may be using standard physical cards, by a live dealer using an electronic selection mechanism, or by a Random Number Generator (RNG) computer selection. Each EGM may included its own RNG, or each EGM may be connected to one or more centralized RNGs that each generate random numbers for one or more games. In the case of a live dealer dealing physical cards, a capture device may determine which cards are dealt and coupled to a graphics generator that makes graphical representations of the cards. Other implementations are also possible.

The baccarat screen 100 includes a number of areas, each providing information to a player or players. The central portion of the baccarat screen 100 includes a banker card section 120 and a player card section 130. Each of the card sections 120, 130 displays cards dealt to the respective player or banker. Each card section 120, 130 additionally includes a respective score window, 121, 122, which totals the player or bankers cards, respectively, as they are dealt. Recall that baccarat scores are always single digit because only the last digit of the total is used to score a baccarat game.

A player chip section 140 shows the current chip holdings of the player, along with one or more windows 141, 142, 143 displaying present betting information such as current wager, result of last wager, and total chips held. Of course, additional windows may be added or removed without deviating from the scope of the invention. A betting field 150 includes discrete areas 152 and 154 in which the player may bet on the banker or player, respectively. Wins on either the banker or player may have different payout odds, in order to give a very small house advantage. In many baccarat games, wins on the player are paid 1:1, i.e., even-money where a winning $10 bet pays $20. Wins on the banker, conversely, typically include a small commission, either directly, or as a lower payout on particular hands. In the example illustrated in FIG. 5, the payout for a banker winning total of a “6” pays at 1:2. Alternate methods of paying commission to the house are possible.

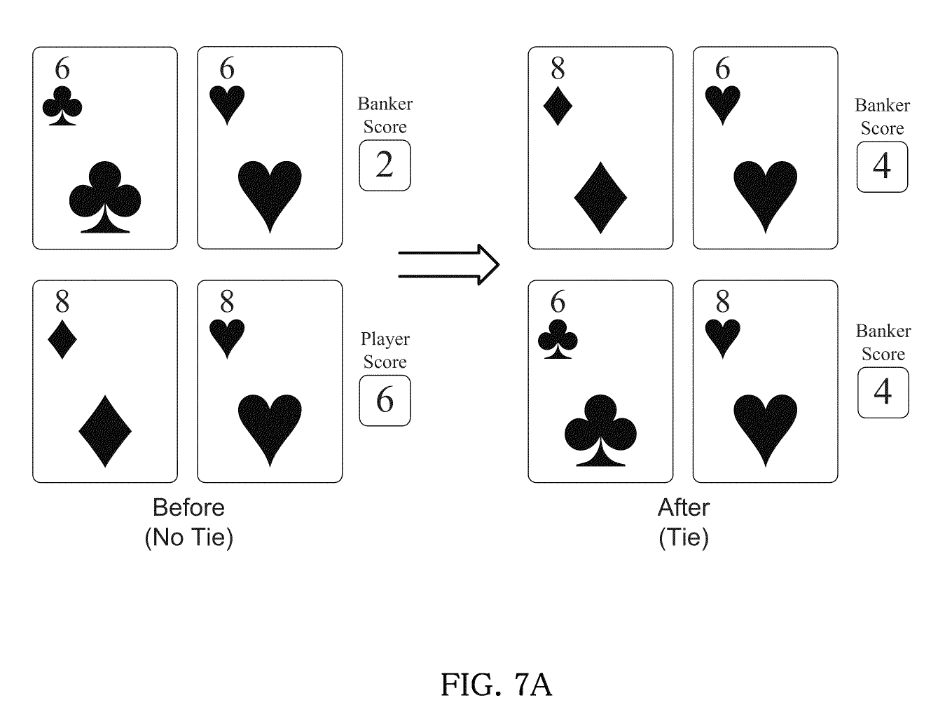

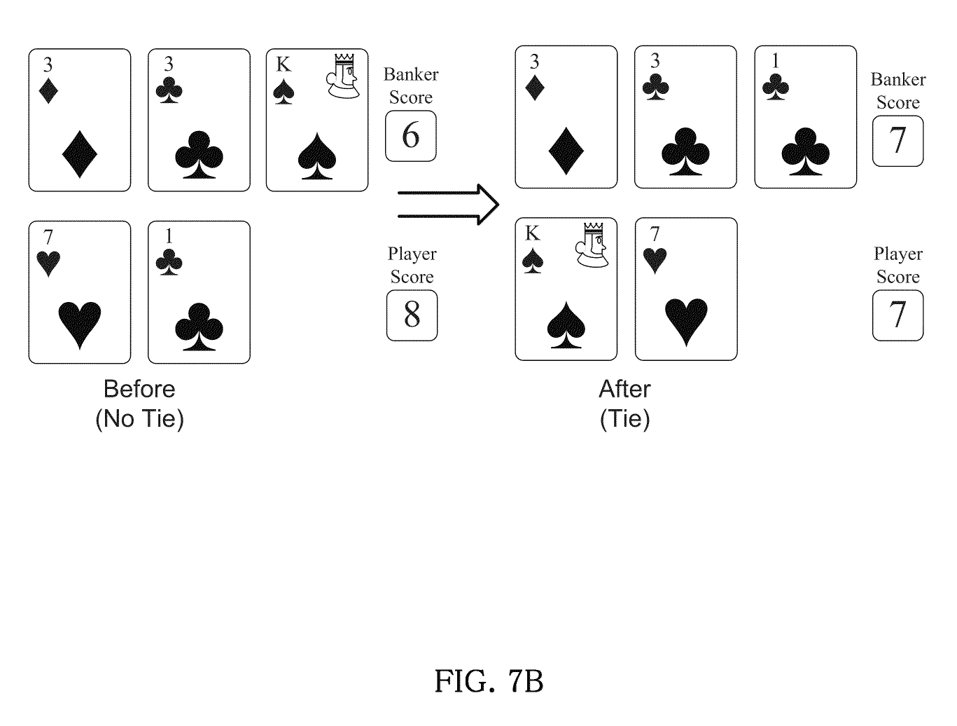

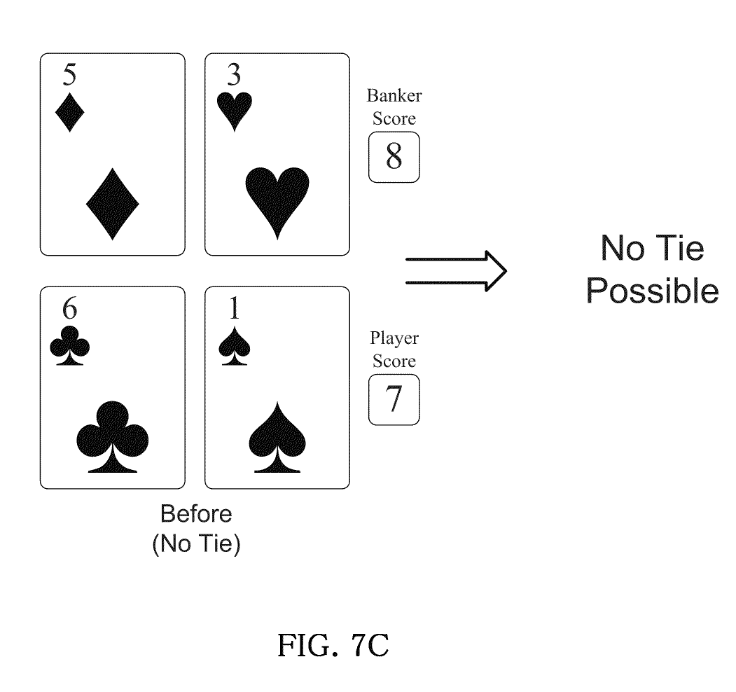

Additionally, the betting field 150 includes an area 156 where the player may bet that the result of the hand will be a tie, meaning that the player and bank end with the same score. In most baccarat systems a tie bet is a house-favored bet, i.e., one that, over time, pays the house well more than it costs the house in payouts. Further, according to embodiments of the invention, the baccarat screen 100 includes an area 157 labeled “make a tie.” This is another bet that a player may make, related to ties, that is described in detail below with reference to FIGS. 7A-7C.

A set of utility buttons 160 allows the player of the EGM hosting the baccarat screen 100 to perform various functions. For example a collect button 161 cashes out the player, such as by printing a ticket at the ticket printer 38 (FIG. 1A), or by transferring the player's winnings into an electronic account. A language button 162 changes the language on the baccarat screen 100. Pressing a game info button 163 brings up one or more information screens (not separately illustrated) to inform the player how the game is played. A volume button 164 raises or lowers the volume of the EGM. The two final buttons in the set of utility buttons are a “clear” button 167 which clears the current bet (provided the game has not been started yet), as well as a “deal” button 168, which causes the baccarat game to proceed immediately, without waiting.

A game report section 170 displays the outcomes of the previous games of baccarat, each of which is one of three outcomes, Player—“P,” Banker—“B,” or Tie—“T.” There are many typical game report screens, and pressing one of the change report buttons 171, located on either side of the game report section 170, causes the game report to cycle through the various screens. Examples of game reports include “Main Road,” Big Eye,” “Little Pig,” and “CockRoach Pig,” as is known in the industry.

In general, to play baccarat using the baccarat screen 100 as illustrated in FIG. 5, the player uses a mouse or other pointing device to select one of the representations of chips in the player chips section 140, then selects one or more of the betting areas in the playing field 150. Multiple bets are allowed. In other words, a player can bet on both the player and the banker simultaneously. Additionally the player can bet the Tie or “Make a Tie.” In one particular embodiment, described below as the “Make a Tie” side bet, is only available to a player who is also currently making a Tie bet.

Once the bets have been placed, the player either selects the deal button 168, or simply waits for the baccarat game to deal the player and banker cards. After the cards are dealt, the EGM 70 hosting the baccarat screen 100, or other device, totals the points of the dealt cards and determines the winner. Winning wagers are added to the player's total and losing wagers are removed from the total.

Having an automated baccarat game creates a more approachable game for players who may be timid or shy. Oftentimes new players are reluctant to try a new game for fear of appearing foolish for not knowing how the game is played, especially when other people may be nearby. The baccarat game illustrated by the screen 100 is approachable, easy to follow, and includes information screens selectable by the game info button 163 to instruct the player how to play.

Additionally, electronic games are typically more cost effective for a casino to implement than table games because it is unnecessary to pay wages for a dealer or table supervisor. Further, in the case where play at the table game is electronically tracked, as described above with reference to FIG. 4, no separate casino employee is needed to enter player tracking data, as an electronic game may record player actions automatically.

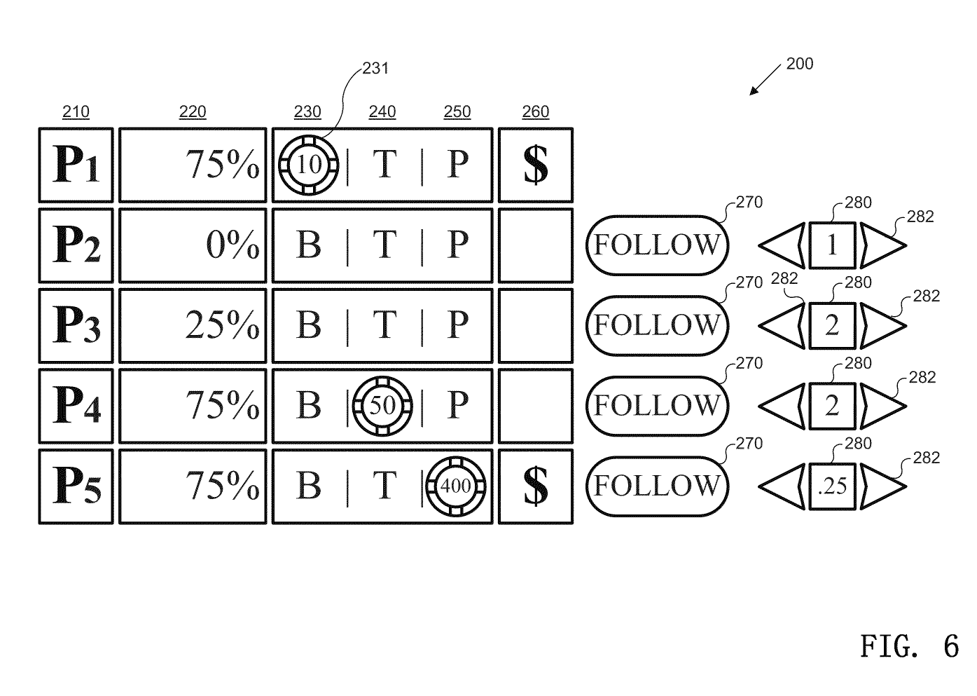

Different than the game report section 170, the baccarat screen 100 additionally includes a player results section 180, which provides information to the player about other players playing baccarat. The player results section is described in detail with reference to FIG. 6.

FIG. 6 is a block diagram of a game report section 200, which is an example of the game report section 180 of FIG. 5. Generally, the game report section 200 provides information to the player about other players playing baccarat at other games that are linked to the particular game being played. As described above, the other players may be physically near one another, such as all within a particular carrousel or bank, or may be locally separated, such as in different areas of a casino, or may be distant to one another, such as by playing baccarat over the internet.

In the game report section 200 of FIG. 6, a player identification column 210 lists all of the connected players upon which data is being collected and shown. In this instance there are five players, labeled P1-P5, but more or fewer players may be present. For convenience, the player of the present EGM 70 is listed as P1, while other players are similarly numbered. In other embodiments the players may be identified by name, symbol, icon, or avatar.

A results column 220 provides win information on each of the players, illustrated as a winning percentage. In this example players P1, P4, and P5 have won 75% of their games, while P3 has won only 25%. Player P2 has not won any games since the result tracking began. The percentage may track a ‘per game’ outcome, where if a player makes bets on all of the player, banker and tie, the player is guaranteed a win, or may be tracked on a ‘per bet’ outcome. In the latter case, betting on all three outcomes simultaneously would yield a 33% win ration, as only one of the three possible outcomes is possible.

Betting columns 230, 240, and 250 illustrate the particular bets being made by each player. Betting column 230 illustrates when, and how much, each player is betting on the banker. Betting column 240 illustrates when, and how much, each player is betting on a tie outcome. Betting column 250 illustrates when, and how much, each player is betting on the player, i.e., themselves. A particular number on a chip icon 231 marks how much any particular player is wagering on any particular outcome. The chip icons 231 may be color-coded to denomination or to traditional colors for the banker, player, and tie.

A summary column 260 provides the player a report of how each other player is fairing in the game, illustrated as a single icon. The summary column 260 is the easiest way to determine how another player is playing. For example, a dollar sign icon may be included in the summary column 260 of those players who have made recent successful large wagers. Other icons may indicate a player who has had a long series of winning outcomes. Still other icons may indicate a player who satisfies criteria of betting small amounts on losing hands while consistently betting large amounts on winning hands. In some embodiments the summary level indicated in the summary column 260 is determined by analyzing credit outcomes at various times. The size, shape, appearance, or even selection of particular icons or symbols in the summary column 260 may directly or generally translate to an amount measured in multiples of base credits. The icons in the summary column 260 may be animated to draw additional attention to the player. Additionally the icons may be accompanied by various sounds, or the sounds may be played by the EGM 70 without the icons appearing. Further, the icons may be animated, i.e., include a motion component to draw further attention to them.

Icons or animations need not be limited to the summary column 260, but may, in fact, be located anywhere on the baccarat screen 100. For instance an animated “fire” symbol may wrap around the player identifier 210 when a player is particularly “hot,” that is, when the player is on a winning streak or has above a threshold level of total wins. Other animations may indicate that a player is “cold,” or a “cobweb” icon may indicate a long time between wins of a particular player. Various “lucky” or “unlucky” symbols for various cultures may be included as well. For example a “rabbit's foot” icon may be associated with a player who is “lucky,” that is, one that is doing well, while a “black cat” icon may be associated with an “unlucky” player.

Knowing how other players are performing relative to one another is important because embodiments of the invention allow a player to “follow” another player's bets. In other words, by pressing one of the follow buttons 270, the player P1 may automatically make the same bets for player P1 that the followed player is making manually. For instance, with reference to FIG. 6, the player P1 may choose to follow P4, because, by checking the results column 220 it is revealed that player P4 has won 75% of that player's games. In this instance, the player P1 simply selects the follow button 270 adjacent to the player P4. Then, so long as P1 credits are available, each wager made by P4 is automatically additionally made for P1. Winnings are likewise credited to P1.

In another embodiment, in addition to following a particular player, P1 is given the opportunity to make a multiple of another player's bets. For example, instead of matching P4's bets one-for-one, a multiplier factor 280 may be selectively applied by P1 to multiply P4's bets by the selected amount for P1. With reference to FIG. 6, P4's multiplier 280 is presently set at “2,” which means P1 is wagering twice as much as P4, but on the same particular outcomes, as P4. The multiplier factor may be modified by P1 in any way, such as by arrow buttons 282 to increase or decrease the multiplier amount.

Providing such a system as described above allows a novice or other player who feels like they are either incapable or unwilling to make their own wagers to easily participate in the baccarat game. Perhaps a novice player follows another player for the first 20 minutes of the game, until the novice player feels that he or she understands how to play for himself or herself. After feeling more comfortable, the player then ends following the followed player by toggling the follow button 270. After finishing following, the novice player can then place wagers for himself or herself.

In some cases the player may select to follow players who have won less than the other players, perhaps thinking that the player who has performed poorly is “due” to begin a winning streak.

The game report section 200 of the baccarat screen 100 provides not only the ability to follow another player, and thus duplicate the followed player's wagers, but also provides intuitively delivered information about each of the connected player's performances so that the selecting player may easily make a determination of whether to follow another player and, once determined, may make a determination of increasing or decreasing the wagering amount by a multiplication factor.

Described briefly above, embodiments of the invention include another gaming feature that can be used in both electronic gaming forms of baccarat as well as table games. The “make a tie” feature, described in more detail below, provides the player with another wager opportunity to the standard wagers of baccarat.

With reference back to FIG. 5, the outcome of the illustrated game is a tie, with both the banker and the player having been dealt 9 points. Had the player made the “Tie” wager, then that player would have been paid according to the posted odds. In the illustrated game, a Tie wager pays the standard 8:1 odds, although paying other odds is possible, of course.

In addition to the “tie” wager, embodiments of the invention provide the player an additional chance to “make” a tie outcome. In operation, after the initial (and traditional) baccarat game concludes, there is one more opportunity for the player to be paid on a wager. Specifically, if the cards making up the immediately past game can be arranged to make a tie outcome, then a player who wagered that such an outcome would occur is also paid. In this sense the player is “making” a tie, and, if able to do so, is paid.

With reference to FIG. 7A, a small portion of the baccarat screen 100, in particular only the banker and player card outcomes, is illustrated to help describe various combinations of outcomes. In FIG. 7A, the “before” illustration shows the cards as dealt to the banker and to the player. In this instance, the banker had two “six” cards, totaling 2 points, and the player had two “eight” cards, totaling “six” points. Thus the player won this round. If the player also placed a “make a tie” bet, then, in this case, the cards can be arranged to make a tie outcome, as illustrated in the “after” illustration of FIG. 7A, where each of the player and banker hands have the same score. In practice, the baccarat screen 100 may move the cards in an animation sequence to build excitement and illustrate to the player exactly how the cards are arranged into a tie game.

In other embodiments the EGM may allow the player to arrange the cards himself or herself, at the end of the game, with a pointing device or other method. The EGM may optionally include a countdown clock to display a time period in which the rearrangement must be completed. If the player completes the tie, the payback is made. If the player does not complete the tie, then the EGM does not pay. In other embodiments the EGM may pay whether or not the player could arrange the cards into a tie, provided a tie could, in fact, be made. Further embodiments may combine concepts, by moving some of the cards while requiring that the player move the rest, or may move cards to a winning position automatically over time, while also allowing the player to “beat the clock.”

FIG. 7B is a diagram illustrating another round of baccarat in which a tie is not naturally dealt but can be made by rearrangement. With reference to FIG. 7B, the banker is dealt two “threes” and a King, while the player is dealt a “seven” and a “one.” The player wins the dealt hand, eight points to six. Then, if the player made the side-bet “make a tie,” the cards are rearranged to the position illustrated as “after,” in which the King and “one” are swapped, thus making a tie where each of the banker and player has seven points. This example differs from the one in 7A to illustrate that any combination of two or three may make either the player or the banker's hands after rearrangement.

FIG. 7C is a diagram illustrating another round of baccarat in which a tie is not naturally dealt, nor can be made by rearrangement.

In this example the banker is dealt a “five” and a “three” to total eight points. The player is dealt a “six” and a “one,” for a total of seven. Differently than the examples above with respect to FIGS. 7A and 7B, there is no way to rearrange the four illustrated cards into two groups of two cards that have equal values. Thus, had the player wagered that such a rearrangement would be possible, the player would lose the wager.

In some embodiments of the invention the “make a tie” wager, as described above, is a “legal” wager, according to these modified baccarat rules, only when a corresponding “tie” bet is also made. In other embodiments there is no such requirement that a “tie” bet be simultaneously made.

Additionally, in some embodiments the wager amount for the “make a tie” wager is automatically tied to the size of the “tie” wager. In some implementations, the “make a tie” wager must be exactly one-half the size of the “tie” wager. In other words, a player would select a wager for a “tie” bet, then, when selecting the “make a tie” area 157 (FIG. 5) an amount equal to one-half the amount wagered for the “tie” bet would be placed in the “make a tie” area 157 (and correspondingly deducted from the player's holdings). In cases where the “tie” bet was an odd value, the “make a tie” bet would be rounded to the nearest minimum denomination.

Thus, as described above, embodiments of the invention overcome the problem of finding information about neighboring players in an electronic baccarat system by displaying each player's bet on each game, along with a statistical summary of how that person is doing, thereby making it easy for players to see what others are doing and recall whether they've been consistently winning or not.

Additionally, embodiments of the invention provide a mechanism by which a player can select a player to bet upon and enact that wager, or multiple thereof, through a gaming machine.

Further, embodiments of the invention provide an interesting manner of handling tie outcomes. Because tie bets are relatively rare in baccarat, embodiments of the invention provide a mechanism to increase the likelihood of making a tie event, along with the opportunity for a player to profit from such a successful wager.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of playing baccarat, comprising:
dealing a hand of cards to both a player and to a banker; and
paying a winning amount to a player who correctly wagered that the cards dealt to the player and to the banker could be rearranged into a pair of hands in which the rearranged player hand and the rearranged banker hand have equal values.

2. The method of claim 1 in which paying a winning hand comprises paying 3:1 an amount wagered.

3. The method of claim 1 in which, in order to wager that the dealt cards could be rearranged into hands having equal value, the player must also wager that dealing the hand of cards to both the player and to the banker will result in the dealt hands having equal values.

4. The method of claim 1 in which dealing a hand of cards comprises initiating a Random Number Generator.

5. The method of claim 1 in which the player is responsible for rearranging the cards dealt to the player and to the banker into the pair of hands in which the rearranged player hand and the rearranged banker hand have equal values.

6. A Baccarat system, comprising:
a dealing facility for dealing a player hand and a banker hand;
a comparator structured to compare values of the player hand to the values of the banker hand;
a card-moving system structured to rearrange the dealt cards into a modified dealer hand and a modified player hand; and
an awarder structured to pay an award when a player correctly wagered that a value of the modified banker hand would equal a value of the modified player hand.

7. The system of claim 6 in which the card-moving system is a computer-controlled automatic system.

8. The system of claim 6 in which the card-moving system accepts a user input.

9. The system of claim 6 in which the awarder is controlled by an electronic gaming device.

10. The system of claim 6 in which the dealer facility includes a human dealer.

11. A method of showing outcomes of multiple players playing individual electronic gaming devices that are coupled to one another, comprising:
gathering information related to gameplay of the multiple players;
applying filtering rules to the gathered information to generate filtered results;
displaying the filtered results about all of the multiple players on screens of all of the multiple players of the individual electronic gaming devices that are coupled to one another; and
displaying individual gameplay of each of the multiple players to the others of the multiple players.

12. The method of claim 11 in which the filtering rules include a threshold above which a player is labeled as having a desirable history of play.

13. The method of claim 11 in which displaying individual gameplay comprises displaying one or more wagers.

14. The method of claim 11 in which the filtered results are displayed only to those players who have satisfied a criteria.

15. The method of claim 14 in which the criteria comprises playing as an identified player.

16. A system for displaying results of multiple players of connected electronic gaming devices, comprising:
a data collector structured to receive information related to gameplay of the multiple players;
a filter structured to apply filtering rules to the collected gameplay information of the multiple players to generate filtered data; and
a display section structured to show the filtered data and individual gameplay information of the multiple players on the connected electric gaming devices.

17. The system of claim 16 in which the display section is structured to display filtered data and gameplay information only to selected ones of the multiple players.

18. The system of claim 17 in which the selected ones of the multiple players are identified players.

19. The system of claim 16 in which at least one of the connected gaming devices is a hand-held device.

20. The system of claim 16 in which the filter comprises a comparator structured to compare an initial amount of credit available to one of the multiple players to a present amount of credit available to the one of the multiple players.

21. A method of playing baccarat on one of a series of linked baccarat games on which a plurality of players are respectively playing, the method comprising:
displaying an indication of previous results of past baccarat games for the plurality of players;
accepting an indication that a first of the plurality of players is following the wagers of a second of the plurality of players; and
after such an indication is received, making wagers for the first of the plurality of players based on the wagers of the second of the plurality of players.

22. The method of claim 21 in which making wagers for the first of the plurality of players comprises making identical wagers of the second of the plurality of players.

23. The method of claim 21 in which making wagers for the first of the plurality of players comprises making the same wagers as the second of the plurality of players but in different amounts than for the second of the plurality of players.

24. The method of claim 23 in which the different amounts are related by a multiplication factor.

25. The method of claim 24 in which the multiplication factor is less than one.

26. The method of claim 21 in which accepting an indication that a first of the plurality of players is following the wagers of a second of the plurality of players comprises accepting a screen selection.

27. The method of claim 21, further comprising displaying a selectable indicator on the series of linked baccarat games that, when selected, serves as indication that the first of the plurality of players is following the wagers of the second of the plurality of players.

28. The method of claim 27 in which the selectable indicator is structured to toggle from a selected to an unselected state.

29. A system of linked baccarat games on which a plurality of players are respectively playing, comprising:
a display on each of the linked baccarat games that includes a player results section to display an indication of previous results of past baccarat games of each of the plurality of players; and
a selectable portion of the display structured to accept an indication that a party is following the wagers of one of the plurality of players.

30. The system of claim 29 in which the party making the indication is one of the plurality of players.

31. The system of claim 29 in which the selectable portion is labeled “follow.”

32. The system of claim 29 in which the selectable portion of the display is only enabled for those of the plurality of players who satisfy one or more criteria.

33. The system of claim 32 in which one of the one or more criteria is being identified.
